(19) United States
(12) Patent Application Publication
(10) Pub. No.: US 2017/0140316 A1
(43) Pub. Date: May 18, 2017

(54) USE OF MULTIPLE STORAGE CAVERNS FOR PRODUCT INVENTORY CONTROL

(71) Applicant: Air Liquide Large Industries U.S. LP, Houston, TX (US)

(72) Inventor: Ronald STRYBOS, Kountze, TX (US)

(21) Appl. No.: 14/943,356

(22) Filed: Nov. 17, 2015

(51) Int. Cl. G06Q 10/06; G06Q 50/06

(52) U.S. Cl. CPC G06Q 10/06315; G06Q 50/06

(57) ABSTRACT

An inventory management method is provided, which includes filling a first salt cavern with a product gas, removing all the working gas from a second salt cavern when the frequency requirement to empty the second salt cavern is reached, while concurrently, removing and replacing the gas product from the first salt cavern as supply and demand dictate, analyzing the frequency requirement for emptying the first salt cavern, calculating the time to fill the second salt cavern, filling the second salt cavern with a product gas, removing all the working gas from the first salt cavern when the frequency requirement to empty the first salt cavern is reached, while concurrently, removing and replacing the gas product from the second salt cavern as supply and demand dictate, analyzing the frequency requirement for emptying the second salt cavern, calculating the time to fill the first salt cavern, and repeating steps b)-j).

### BACKGROUND

The storage of gases and liquids in solution mined salt caverns, whether leached in domal or stratified salt formations are required to be emptied periodically for government required testing and for accounting and inventory verification. The stored products typically include hydrogen, nitrogen, carbon dioxide, air, methane, ethane, ethylene, propylene, propane, ethane/propane mix (LPG), butane, or pentane.

In a single cavern storage configuration, it was found that business interruptions and product distribution outages are caused by the requirement to empty the cavern of product. This invention claims that by utilizing an inventory management system and multiple caverns the business interruption and product distribution outages are minimized.

### SUMMARY

An inventory management method is provided, which includes filling a first salt cavern with a product gas, removing all the working gas from a second salt cavern when the frequency requirement to empty the second salt cavern is reached, while concurrently, removing and replacing the gas product from the first salt cavern as supply and demand dictate, analyzing the frequency requirement for emptying the first salt cavern, calculating the time to fill the second salt cavern, filling the second salt cavern with a product gas, removing all the working gas from the first salt cavern when the frequency requirement to empty the first salt cavern is reached, while concurrently, removing and replacing the gas product from the second salt cavern as supply and demand dictate, analyzing the frequency requirement for emptying the second salt cavern, calculating the time to fill the first salt cavern, and repeating steps b)-i). The gas product may be hydrogen, nitrogen, carbon dioxide, air, methane, ethane, ethylene, propylene, propane, ethane/propane mix, butane, or pentane.

An inventory management method is provided, including introducing a gas product into salt cavern Q out of a total of Q caverns, where Q is a number greater than 1, setting cavern counter N to 1, setting emptying counter to R=Q calculating time to fill cavern N with gas product, fill cavern N with gas product, empty salt cavern R to meet frequency requirement, removing and replacing the gas product from salt cavern N as supply and demand dictate, analyzing the frequency requirement for emptying salt cavern N, predicting the duration until a maximum acceptable impurity limit is present in the product gas removed from cavern N, and removing all the working gas from salt cavern N when the maximum acceptable impurity limit is reached, then replacing the working gas in salt cavern N, while concurrently, basing the decision upon the value of N: N<Q, setting emptying counter R=N, then setting cavern counter to N=N+1, N=Q, setting emptying counter R=N, then setting salt cavern counter to N=1, then repeating steps b)-f).

### BRIEF DESCRIPTION OF THE FIGURES

FIG. 1 illustrates one embodiment of the present invention.

FIG. 2 illustrates another embodiment of the present invention.

FIG. 3 illustrates another embodiment of the present invention.

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

In a single cavern storage configuration, it was found that business interruptions and product distribution outages are caused by the requirement to empty the cavern of product. This invention claims that by utilizing an inventory management system and multiple caverns the business interruption and product distribution outages are minimized.

Multiple caverns can be 2 or more caverns that the same products are stored in. The caverns are connected on the surface by pipeline and pump or compressor stations.

Definitions of terms used herein:

Primary cavern—the main cavern used to store products and provide products to customers.

Reserve cavern—the cavern used as the back up to store products and provide products to customers.

Base gas—the volume of gas that is the permanent inventory of the cavern, and is used to maintain adequate minimum pressure within the cavern.

Working gas—the volume of gas in the cavern in addition to the base gas, and is available to supply customer demands.

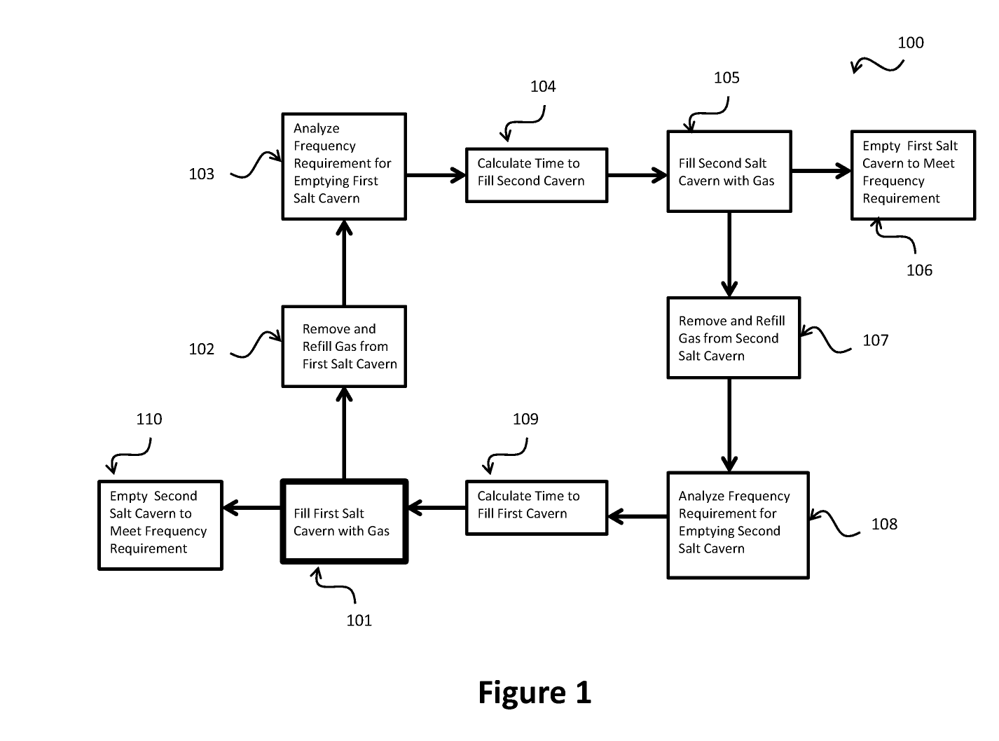

Turning now to FIG. 1, one embodiment of an inventory management method 100 is provided. As shown in FIG. 1, the method 100 includes introducing a gas product into a first salt cavern 101. The gas product can be hydrogen, nitrogen, carbon dioxide, air, methane, ethane, ethylene, propylene, propane, ethane/propane mix, butane, or pentane. The gas product is introduced to the first salt cavern and stored under pressure.

Under normal operation, the gas product is removed from the first salt cavern during times of high demand and/or low availability, and the gas product is replaced in the first salt cavern during times of low demand and/or high availability 102. An analysis is made of the frequency requirement for emptying the first cavern 103. Based on this predicted time for emptying the first cavern, and thus removing it from service, a calculation is made to determine the time required to fill a second cavern 104.

Based on this calculation, the second cavern is filled with fresh gas product from the associated pipeline 105. Once the predicted time for emptying the first cavern is reached, all of the working gas is allowed to be removed from the first salt cavern 106. Concurrently, under normal operation, the gas product is now removed from the second salt cavern during times of high demand and/or low availability, and the gas product is replaced in the second salt cavern during times of low demand and/or high availability 107.

An analysis is now made of the frequency requirement for emptying the second cavern 108. Based on this predicted time for emptying the second cavern, and thus removing it from service, a calculation is made to determine the time required to refill the first cavern 109.

Based on this calculation, the first cavern is refilled with fresh gas product from the associated pipeline 101. Once the predicted time for emptying the second cavern is reached, all of the working gas is allowed to be removed from the second salt cavern 110. Concurrently, under normal operation, the gas product is now removed from the first salt cavern during times of high demand and/or low availability, and the gas product is replaced in the second salt cavern during times of low demand and/or high availability 102. And the alternating cycle continues, with each salt cavern being emptied and refilled once the frequency requirement for emptying is reached, while the other salt cavern takes over with satisfying customer demands.

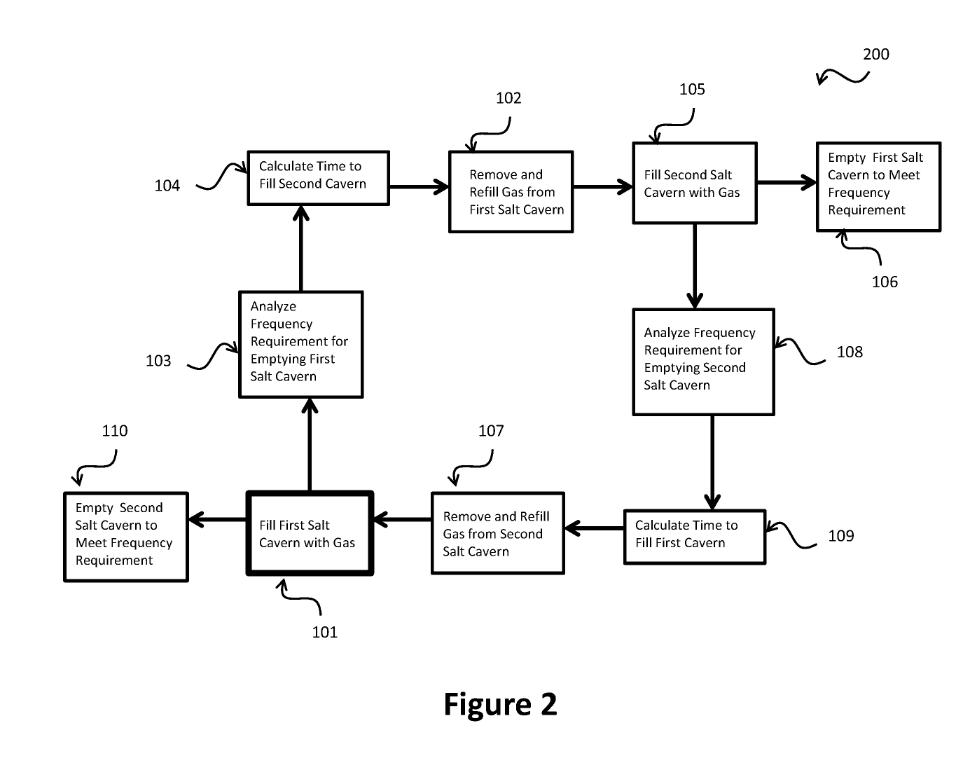

Turning now to FIG. 2, another embodiment of an inventory management method 200 is provided. In the interest of clarity, as the various method steps in FIG. 2 are identical to those of FIG. 1, the same element numbers are used.

The difference between inventory management method 100 and inventory management method 200, is that in method 100 the analysis and calculation/prediction of emptying each cavern is done after the cavern has been put in service. As the customer usage may vary from that which is contractually obligated, additional prediction accuracy may be possible. The specific timing of the analysis, and hence the ultimate accuracy with which the impurity prediction is made is a design choice made by the skilled artisan. In method 200, the analysis and calculation/prediction of impurities is done prior to having the cavern put into service. The analysis is made based, for example, on historical data, the estimated time that the cavern must be discontinued and emptied is predicted.

Turning now to FIG. 2, another embodiment of an inventory management method 200 is provided. As shown in FIG. 2, the method 200 includes introducing a gas product into a first salt cavern 101. The gas product can be hydrogen, nitrogen, carbon dioxide, air, methane, ethane, ethylene, propylene, propane, ethane/propane mix, butane, or pentane. The gas product is introduced to the first salt cavern and stored under pressure.

An analysis is made of the frequency requirement for emptying the first cavern 103. Based on this predicted time for emptying the first cavern, and thus removing it from service, a calculation is made to determine the time required to fill a second cavern 104. Under normal operation, the gas product is removed from the first salt cavern during times of high demand and/or low availability, and the gas product is replaced in the first salt cavern during times of low demand and/or high availability 102. Based on the calculation, the second cavern is filled with fresh gas product from the associated pipeline 105. Once the predicted time for emptying the first cavern is reached, all of the working gas is allowed to be removed from the first salt cavern 106.

An analysis is now made of the frequency requirement for emptying the second cavern 108. Based on this predicted time for emptying the second cavern, and thus removing it from service, a calculation is made to determine the time required to refill the first cavern 109. Under normal operation, the gas product is now removed from the second salt cavern during times of high demand and/or low availability, and the gas product is replaced in the second salt cavern during times of low demand and/or high availability 107.

Based on this calculation, the first cavern is refilled with fresh gas product from the associated pipeline 101. Once the predicted time for emptying the second cavern is reached, all of the working gas is allowed to be removed from the second salt cavern 110. And the alternating cycle continues, with each salt cavern being emptied and refilled once the frequency requirement for emptying is reached, while the other salt cavern takes over with satisfying customer demands.

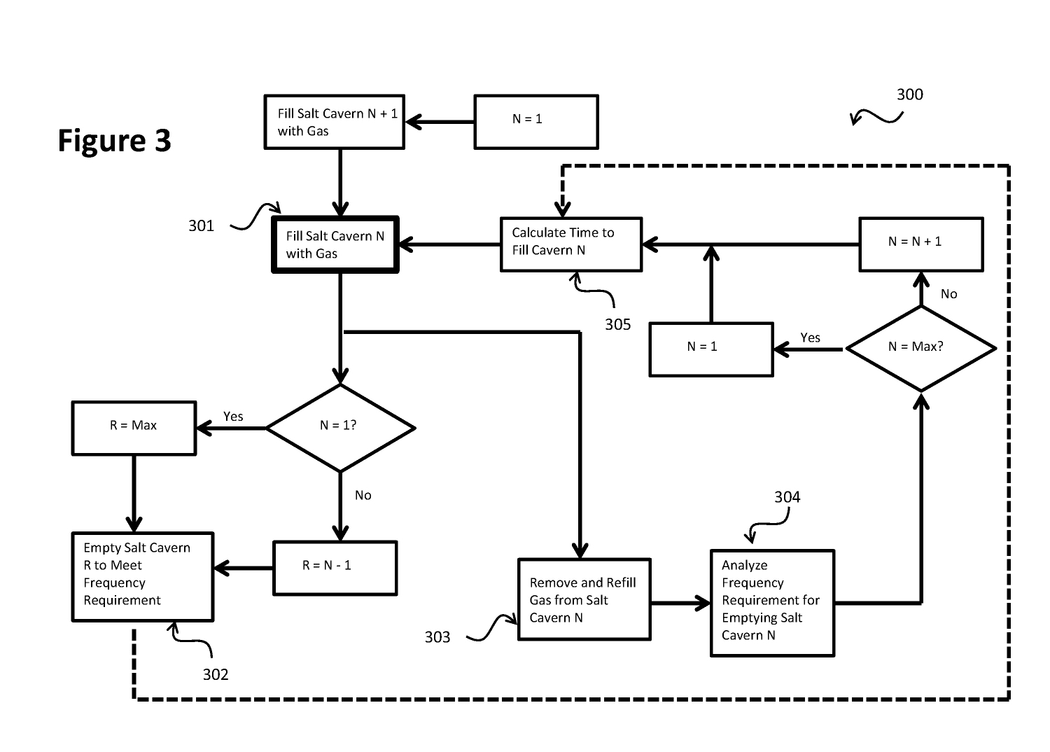

Turning now to FIG. 3, another embodiment of an inventory management method 300 is provided. Whereas the method descriptions provided for inventory management methods 100 and 200 were based on the presence of two working salt caverns, inventory management method 300 is more general, and is based on the presence of X caverns, where X is a number greater than 1, which are intended to be used on concert.

The description that follows uses the model seen above in inventory management method 100, but one skilled in the art would recognize that this method may also be applied with the model seen above in inventory management method 200.

As shown in FIG. 3, the method 300 includes introducing a gas product into salt caverns N and N+1 301. In order to illustrate this system, the initial value for N is established to be 1, and the number of caverns in coordinated operation is 3. For the sake of clarity, as following method is navigated, the current value N will be illustrated in parentheses.

The gas product can be hydrogen, nitrogen, carbon dioxide, air, methane, ethane, ethylene, propylene, propane, ethane/propane mix, butane, or pentane. The gas product is introduced to the first salt cavern and stored under pressure.

A determination is made of which cavern is acting as the primary cavern. An analysis had previously been made of the frequency requirement for emptying the reserve cavern. If N=1 (as is the case with the current example), then cavern counter R is set at the X (the total number of caverns). If N≠1, then R is set at N−1, indicating either way that the cavern previously in use is now to be the cavern to be emptied. All of the working gas is now allowed to be removed from the salt cavern R 302.

Under normal operation, the gas product is removed from the salt cavern N (1) during times of high demand and/or low availability, and the gas product is replaced in the salt cavern N (1) during times of low demand and/or high availability 303.

An analysis is now made of the frequency requirement for emptying the cavern N (1) 304. Now, cavern counter N (1) is either increased by 1 (N=2) or reset to 1 (not applicable for this cycle) depending on which cavern was most recently used.

Based on this predicted time for emptying the current cavern N (1), and thus removing it from service, a calculation is made to determine the time required to refill the next cavern N (2) 305. Based on this calculation, cavern N (2) is refilled with fresh gas product from the associated pipeline 301.

Now, if N=1 (not the case with the current example), then cavern counter R is set at the X (the total number of caverns). If N≠1 (the case with the current example), then R is set at N−1, indicating either way that the cavern previously in use is now to be the cavern to be emptied. All of the working gas is now allowed to be removed from the salt cavern R 302. And the alternating cycle continues, with each salt cavern being emptied and refilled once the frequency requirement for emptying is reached, while the other salt cavern takes over with satisfying customer demands.

The inventory management method essentially includes the following steps:

The inventory management system consists of

1. Filling a salt cavern with product.

2. Analyzing the frequency of the requirement to empty the cavern.

3. Calculating how long it will take to store enough volume in the reserve cavern(s) to provide product to customers when the primary cavern is empty

4. Fill the reserve cavern(s).

5. Empty the primary cavern to meet the required schedule for emptying a cavern.

6. Repeat this process for each cavern to meet required schedule for emptying a cavern.

1-6. (canceled)

7. An inventory management method, comprising:
a) filling a first salt cavern and a second salt cavern with a product gas;
b) removing a first working gas from a first salt cavern to meet a customer usage;
c) removing all of the first working gas from the first salt cavern when a maximum acceptable impurity limit within the working gas is reached, while concurrently;
d) removing a second working gas from the second salt cavern to meet the customer usage;
e) filling the first cavern with the product gas;
f) removing all of the second working gas from the second salt cavern when a maximum acceptable impurity limit within the working gas is reached, while concurrently;
g) removing a first working gas from the first salt cavern to meet customer usage;
h) refilling the second cavern with the product gas;
i) repeating steps c-h

8. The inventory management method of claim 7, wherein the gas product is selected from the group consisting of hydrogen, nitrogen, carbon dioxide, air, methane, ethane, ethylene, propylene, propane, ethane/propane mix, butane, and pentane.

9. The inventory management method of claim 7, wherein the gas product is hydrogen.
